(19) United States
(12) Patent Application Publication
(10) Pub. No.: US 2008/0156783 A1
(43) Pub. Date: Jul. 3, 2008

(54) Portable multi-wire feeder

(76) Inventors: Michael L. Vanden Heuvel, Sherwood, WI (US); Jeffrey R. Thomas, Appleton, WI (US)

Correspondence Address: Tait R. Swanson;FLETCHER YODER, P.O. Box 692289, Houston, TX, 77269-2289, US

(21) Appl. No.: 11/648,353

(22) Filed: Dec. 29, 2006

(51) Int. Cl. B23K 9/28

(52) U.S. Cl. 219/137.2

(57) ABSTRACT

A portable wire feeder system is disclosed that includes multiple wire supplies disposed in a case or luggage. The system has a number of embodiments each including multiple wire sources and at least one wire feeder disposed in the case. In a one embodiment multiple wire supplies and a wire feeder are mounted in a fixed position, and are configured to enable feeding of the wire from either supply to the wire feeder. In other embodiments, either the wire supplies or the wire feeder moves to align the wire supply with the wire feeder. In another embodiment, a wire guide is disposed between the wire feeder and wire supplies. In another embodiment, a second wire feeder is disposed within the case and is configured to align with a second wire supply while the first wire feeder is aligned with the first wire supply.

### BACKGROUND

The invention relates generally to the field of wire feeders and/or welding systems. More specifically, the invention relates to a welding wire feeder.

In certain applications, a welding wire feeder mechanism or wire feeder may be used to feed a welding wire through a torch to a molten weld location in front of the tip of the torch. In many applications, it may be desirable to move the wire feeder to a remote location or simply to a different location in a work area. Additionally, in certain applications, it is desirable to have multiple wire supplies or multiple wire spools enclosed in the portable wire feeder system.

Unfortunately, conventional dual wire feeders are designed as stationary devices intended to remain within a particular work area. These wire feeders are bench or open type feeders designed for indoor use and are too large and heavy for single person transport. Furthermore, portable feeders do not provide multiple wire supplies and require the user to perform the arduous task of manually transporting and swapping spools at the job site.

### BRIEF DESCRIPTION

Embodiments of the present invention enable a multi-wire supply portable feeder disposed in a case or luggage, such as a suitcase or another type of luggage. In general, each embodiment includes multiple wire supplies and at least one wire feeder disposed in a case. In a first embodiment, the system includes a wire supply position adjuster that enables movement of a first wire supply, or a second wire supply, or both into alignment with a wire feeder. The supply position adjuster may include a first supply adjuster configured to move the first wire supply and a second supply adjuster configured to move the second wire supply independently from one another.

In a second embodiment, the supply position adjuster includes a common wire carriage configured to jointly move the first and second wire supplies. In a third embodiment, the first wire supply, the second wire supply, and the wire feeder are mounted in a fixed positions and configured to enable feeding of the electrode wire from either the first wire supply or the second wire supply into the wire feeder. In a fourth embodiment, the wire feeder is adjustable and all or part of the wire feeder is configured to move into alignment with the first wire supply and the second wire supply. In a fifth embodiment, a wire guide is disposed between the wire feeder and the first and second wire supplies. The wire guide is configured to align the wire between the wire feeder and the first and second wire supplies. In a sixth embodiment, another wire feeder is disposed within the case and is configured to align with the second wire supply while the first wire feeder is aligned with the first wire supply.

In each embodiment, a moisture remover and/or heater may be disposed in the case. Additionally the case or luggage may be made out of a plastic material, a durable fabric-like material, a metallic material or a combination thereof. The case may further include a fixed handle, a retractable handle, a set of wheels, or a combination thereof.

### DRAWINGS

These and other features, aspects, and advantages of the present invention will become better understood when the following detailed description is read with reference to the accompanying drawings in which like characters represent like parts throughout the drawings, wherein:

FIG. 1 is a front perspective view of a portable wire feeder system having a wire feeder disposed in a case and configured to receive multiple wire spools (shown exploded) in accordance with one embodiment;

FIG. 2 is a rear perspective view of the case of FIG. 1 illustrating a fixed handle, a retractable handle, and a set of wheels;

FIGS. 3A and 3B are schematic diagrams of the system of FIG. 1, viewed from the perspective of line 3-3, further illustrating an embodiment of the system;

FIGS. 4A and 4B are schematic diagrams of the system of FIG. 1, viewed from the perspective of line 4-4, further illustrating another embodiment of the system;

FIGS. 5A and 5B are schematic diagrams of the system of FIG. 1, viewed from the perspective of line 4-4, further illustrating another embodiment of the system; and

FIG. 6 is a schematic diagram of the system of FIG. 1, viewed from the perspective of line 4-4, further illustrating another embodiment of the system.

### DETAILED DESCRIPTION

As discussed in further detail below, various embodiments of multi-wire feeder are provided that enable a user to transport the wire feeder to a remote location. In general, the system may be used in Gas Tungsten Arc Welding (TIG), Gas Metal Arc Welding (MIG), Flux Cored Arc Welding (FCAW), or Stick welding applications. The wire feeder is typically used for MIG and FCAW welding applications, however the system enables the user to select another welding process (e.g., TIG or Stick) and perform the welding operation without the use of the wire feeder. The system has a number of embodiments each including multiple wire supplies and at least one wire feeder disposed in a case. The multiple wire supplies enable a user to weld a first pass or “root” pass with one wire size or type and then switch to a second wire size or type for the subsequent pass or “fill” passes. The system is one-man portable and may have only a single drive motor to reduce the weight and cost of the unit. The system is designed for outdoor use and encloses the electronics and welding components in a sealed cavity. In some embodiments, the wire feeder and wire supplies may be disposed within a backpack, a fanny pack or belt mounted luggage, a wrist mounted luggage, a shoulder mounted luggage, or a combination thereof. The system may also include a moisture remover and/or a heater element facilitating the welding process in cold environments (e.g., −50 Degree Centigrade), humid environments, or both.

In one embodiment, multiple wire supplies (e.g., wire spools) and a wire feeder are mounted in a fixed position and configured to feed the wire from the supplies to the feeder. In other embodiments, either the multiple wire supplies, or the wire feeder, or both move to align the wire supply with the wire feeder. In another embodiment, a wire guide is disposed between the wire feeder and wire supplies. The wire guide is configured to align the multiple wire supplies with the wire feeder. In another embodiment, a second wire feeder is disposed within the case and is configured to align with the second wire supply while the first wire feeder is aligned with the first wire supply. These features introduced above are now discussed in further detail below with reference to the figures.

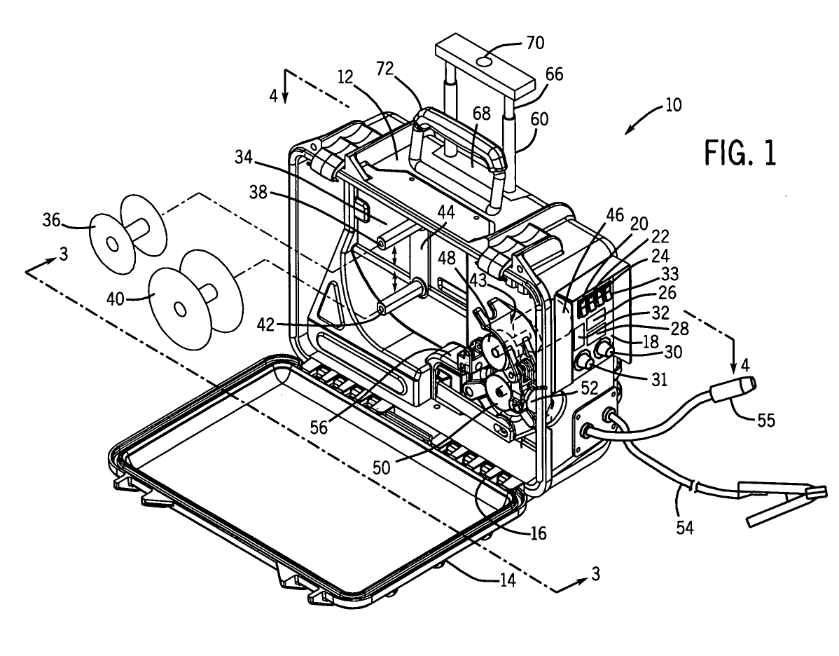

Turning now to the drawings, FIG. 1 is a perspective view of the portable multi-wire feeder system 10 illustrating the case or suitcase 12 in accordance with a first embodiment. The case 12 may be made out of a variety of metallic and/or synthetic materials, which may form a soft shell or a hard shell to protect the internal components. These materials may include a plastic material, a durable fabric-like material, a metallic material, or a combination thereof. For example, the material may include polypropylene, polycarbonate, fiberglass, aluminum, etc. The case 12 may include a door 14 and hinge system 16 that enables the user access to the internal cavity of the case 12. The case 12 and the door 14 may incorporate a locking system to secure the door in a closed position during transport and operation. For example, a snap-latch system or zipper system may be used to secure the door 14. A seal also may be disposed between the door 14 and the case 12 to create a watertight and/or airtight environment for the internal components.

A control panel 18 is located on a front side of the case 12 and enables the user to adjust and/or monitor welding parameters, the wire feed operation, and so forth. The control panel 18 includes a number of user control devices. In general, the control panel 18 may include a variety of knobs, switches, pushbuttons, electrical connectors, analog or digital gauges, analog or digital displays, or a combination thereof. These various control items on the control panel 18 may correspond to the wire feeder, the torch, the power supply, the gas supply, the heater, or a combination thereof. In addition, all or part of the control panel 18 may be detachable from the case 12. For example, the control panel 18 may snap fit into the case 12, such that it can be removed and operated independent from the case 12. In the present embodiment, the control panel includes a jog/purge control 20, a trigger hold switch 22, a power control switch 24, a voltmeter 26, a wire speed/amperage meter 28, a wire speed control or wire feed control 30, a voltage control 31, and a welding process selection control 32. The welding process selection control 32 enables a user to remotely select and configure the power source for the desired welding operation. For example, the user may select between TIG, MIG, FCAW, or Stick welding. Additionally, in the situation where multiple wire feeders or drives are included, the control panel may also include a selector mechanism or switch 33 enabling the user to select the desired wire feeder or drive. As discussed, the control panel 18 provides a user control device and enables the user to remotely manage the welding parameters.

FIG. 1 further illustrates one embodiment of the present invention. The case 12 has an internal cavity 34 that is configured to house multiple wire supplies and at least one wire feeder. For example, a first wire supply or wire spool 36 may be positioned on a first supply adjuster or support 38, while a second wire supply or spool 40 may be positioned on a second supply adjuster 42, all of which may be disposed inside the case 12 and sealed from the environment. The first supply adjuster 38 and second supply adjuster 42 may be configured to independently align the respective wire supply 36, 40 with a wire feeder or drive assembly 43. The first wire supply 36 may be generally positioned above the second wire supply 40 or vice versa. Additionally, the first supply adjuster 38 and second supply adjuster 42 may be configured to engage a track 44 to aid in the alignment process.

In general, the wire supply 36, 40 is fed into the wire feeder 43 that drives the weld wire out through wire feed port 52 and into a welding torch. In some embodiments, the wire feeder 43 may be configured to simultaneously feed wire from both wire supplies 36, 40, for example, out through the single port 50 or through independent ports. For example, the wire feeder 43 may feed the wire from supplies 36, 40 to first and second torches or other applications. As a result, the wire feeder 43 in conjunction with the dual wire supplies 36, 40 may enable multiple operations to be performed simultaneously. Also, some embodiments may include additional wire supplies (e.g., 3, 4, 5, 6, or more), additional wire feed ports, and a configuration of the wire feeder 43 enabling wire feeding from all of some of these wire supplies to a single application (e.g., torch) or multiple applications (e.g., torches) at the same time.

The wire feeder 43 includes a drive motor or drive 46, a drive roll 48, and a support roll 50. The drive motor 46 may be an electric motor, pneumatic motor (e.g., air-driven motor), gasoline engine, etc. In general, each embodiment encloses at least one wire feeder 43 and/or multiple wire supplies 36, 40 in the sealed cavity 34 of the case 12, thus providing protection from the environment. Additionally, the carrying case 12 may also be used to protect other welding components from the environment in addition to the wire feeder 43 and the wire supplies 36, 40. Additional wire feeders, additional wire supplies, welding supplies, welding inspection tools, and portable power supplies are a few examples of welding components that may be disposed in the carrying case 12. A number of different embodiments will be discussed in more detail below.

The case 12 also includes or is configured to couple with a welding ground cable 54 and a power cable 55. The welding ground cable 54 provides a ground for the system 10 and the power cable 55 provides power to the welding torch. Additionally, a moisture removal system may be included in the case 12. The moisture removal system may include a heater 56 or other moisture removal or exclusion techniques. The heater 56 also may be configured to raise the temperature of the wire for a particular application. This may be particularly beneficial for cold environments and/or for increasing the ductility or other characteristics of the wire. In some embodiments, the case 12 may include temperature and/or humidity sensors coupled to the control panel 18 thereby facilitating feedback control of the heater 56. For example, it may be desirable to maintain a particular temperature or humidity level within the case 12, and the feedback sensors may trigger the heater 56 to engage or disengage to maintain a particular environmental state within the case 12. In some embodiments, the case 12 may be airtight, watertight, or both, thereby creating a closed environment within the case 12. A hermetically sealed configuration of the case 12 may facilitate the environmental control within the case 12, while also keeping out moisture, dirt, or other pollutants from corrupting or damaging the wire feeder 43 and other internal components.

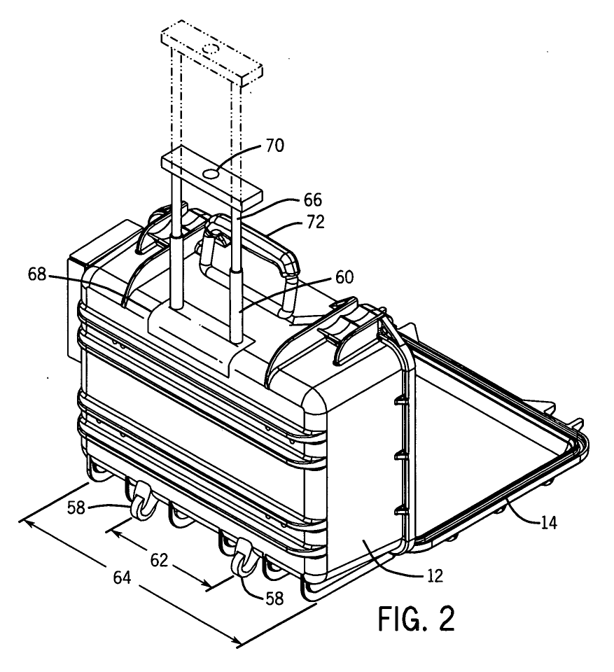

Referring to FIGS. 1 and 2, the case may also include a set of wheels 58 and a retractable handle 60. The wheels 58 and the retractable handle 60 allow the user to transport the system 10 in situations where it is more convenient to roll the system. The distance between the wheels 58 is referred to as the wheel base 62. One particularly useful aspect of the present embodiment shown is that the wheel base 62 is at least 60% of the width 64 of the carrying case 12. This wide wheel base 62 prevents the case from tipping over during transport by distributing the load to the outer edges of the case, thereby counteracting any load shifting that may occur during transport. Retractable handle 60 includes telescope segments 66 that enable the handle 60 to collapse down into a handle housing 68 located in the case. A button 70 is included on the handle to disengage a locking feature of the handle, allowing the user to retract the handle. When retracted, the handle 60 reduces the profile of the system, thereby reducing the amount of room required for storage or transport.

In addition to the retractable handle 60, the case 12 may further include a fixed handle 72 handles (i.e., fixed to the case) that may be positioned on the top of the case 12. The handle 72 enables the user to lift and transport the welding system in situations where carrying it is most convenient. The handle 72 also may be coupled to the case 12 via a hinge, such that the handle 72 is collapsible or foldable onto the case 12. Additionally, a shoulder strap (not illustrated in the figure) may be attached to the case 12 to further facilitate transport. In some embodiments, the case 12 also may include a pair of shoulder straps and padding to enable carriage on a user's back. For example, the shoulder straps may be removably disposed in a compartment, such that they can be removed if desired for a backpack configuration. Also, the padding may be removably disposed in a compartment for use in such a configuration. Some embodiments also may include a security lock system to enable a user to secure/lock the system 10 to a fixture at a work site. For example, the case 12 may include a closed loop or receptacle configured to receive a cable lock. Alternatively, the case 12 may include a cable lock that is retractable from a compartment within the case 12.

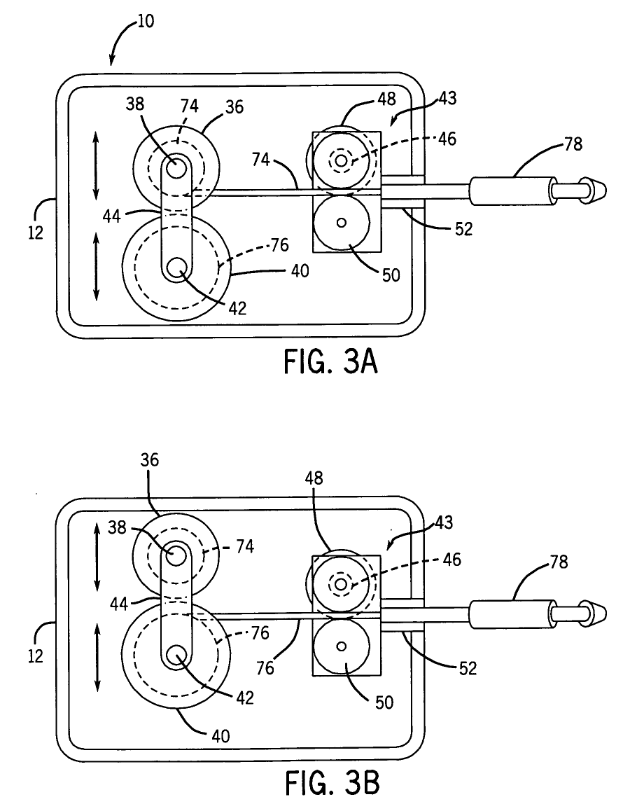

FIGS. 3A and 3B are schematic diagrams of the system of FIG. 1, viewed from the perspective of line 3-3, further illustrating an embodiment of the system. The figures show the wire feeder 43 located in a fixed position inside the case 12. The figure further shows the first wire supply 36 positioned vertically above the second wire supply 40. However, the wire supplies may be positioned in other orientations and may also be fixed in position. FIG. 3A shows a first electrode wire 74 fed to the wire feeder 43 and onto the welding gun 78. Conversely, FIG. 3B shows a second electrode wire 76 fed to the wire feeder 43 and wire gun 78 with the first electrode wire being retained on the spool. Both figures illustrate one application of the system 10 in that a user would make an initial pass or “root” pass using the first electrode wire 74, and then make subsequent passes with the second electrode wire 76. Typically, the root pass electrode wire 74 is smaller diameter than the second electrode wire 76. Again, in some embodiments, the wire feeder 43 may receive and feed wires from both supplies 74, 76 simultaneously to different torches or other applications.

In the application illustrated in FIG. 3, the user feeds the desire wire supply 36, 40 into the wire feeder 43 and then performs the welding operation. Both of the wire supplies may either be fixed or located on a supply position adjuster. For example, the first wire supply 36 may be on the first supply adjuster 38 and the second wire supply 40 may be on the second supply adjuster 42. These supply adjusters 38, 42 may be configured to move independent from one another, or in conjunction with one another, or both depending on the desired movement/alignment. Furthermore, the supply adjusters 38, 42 may be keyed into a single track 44 to help alignment or they may be configured to move both vertically and horizontally. As discussed, the first and second wire supplies 36, 40 maybe mounted in fixed positions within the case and configured to enable feeding of wire from either the first wire supply 36, or the second wire supply 40, or both to the wire feeder 43. In other words, the feeder may be described as a multi-wire feeder configured to feed wire from multiple sources. In some embodiments, a wire guide may be disposed in the housing that aids in the alignment of multiple wire sources to the multi-wire feeder. The wire guide may include multiple conduits that merge to the wire feeder 43, a single conduit than can be rotated or moved at an entry end between the different wire supplies 36, 40, while the outlet end remains in position adjacent the wire feeder 43. The wire guide also may include rollers, channels, or other guiding features to route the wires from the supplies 36, 40 to the wire feeder 43. The wire guide may be used in conjunction with a multi-spool feeder. The multi-spool feeder may be a feeder that can accept more then one wire supply. Additionally, the multi-wire feeder may include a plurality of wire feeders each configured to receive wire from at least one of the multiple sources.

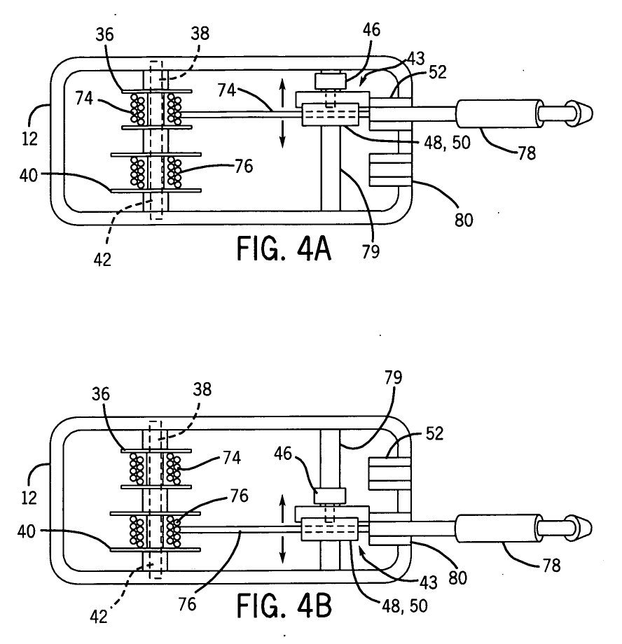

FIGS. 4A and 4B illustrate another embodiment of the present invention and are schematic diagrams of the system of FIG. 1, viewed from the perspective of line 4-4. In this embodiment, the first and second wire supplies 36, 40 are fixed in the case and the wire feeder 43 moves to align with the desired wire supply. A feed position adjuster 79 is provided that enables the user to move all or part of the wire feeder 43 into alignment with the first wire supply 36 and the second wire supply 40. FIG. 4A illustrates the wire feeder 43 aligned with the first wire supply 36 and FIG. 4B illustrates the wire feeder 43 aligned with the second wire supply 40. The figures also show another wire feed port 80 enabling the electrode wire 76 to exit the case 12 and into the welding gun 78. In this application, the user aligns the wire feeder 43 with the desired wire supply 36, 40 and then feeds the wire 74, 76 into the wire feeder 43. The user then performs the welding operation and repeats the process when the second wire supply is required.

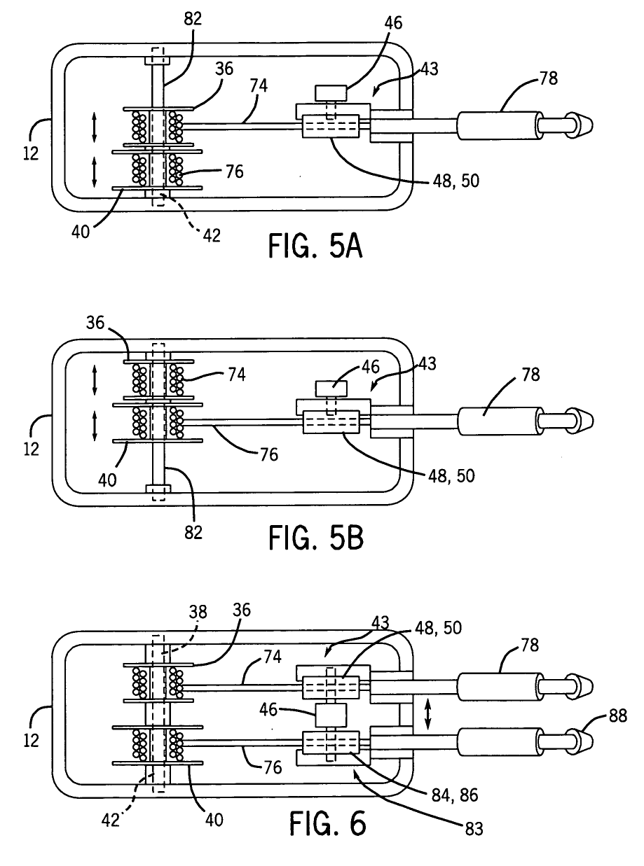

FIGS. 5A and 5B illustrate another embodiment of the present invention and are schematic diagrams of the system of FIG. 1, viewed from the perspective of line 4-4. In this embodiment, the first and second wire supply 36, 40 are positioned on a common wire carrier 82. The supply position adjuster maybe configured to jointly move the first and second wire supplies 36, 38 or enable the user to independently move each wire supply along the carrier 82 in order to align the supply with the wire feeder 43. FIG. 5A illustrates the first wire supply 36 aligned with the wire feeder 43 and FIG. 5B illustrates the second wire supply 40 aligned with the wire feeder 43. In this application, the user aligns the desired wire supply 36, 40 with the wire feeder 43 and then feeds the wire 74, 76 into the wire feeder 43. As discussed, the user aligns the desired electrode 74, 76 to the wire feeder 43 by sliding or moving the wire supply 36, 40 along the common wire carriage 82. The user then performs the welding operation and repeats the process when the second wire supply is required. In this embodiment, and in previous embodiments, the system 10 may include an automatic positioning system configured to move the wire feeder 43, or the wire supplies 36, 40 in combination, or the wire supplies 36, 40 independent from one another, or a combination thereof, to facilitate wire alignment automatically rather than having a user perform this function.

FIG. 6 illustrates another embodiment of the present invention and is a schematic diagram of the system of FIG. 1, viewed from the perspective of line 4-4. In this embodiment, the first and second wire supply 36, 40 are fixed in the case and a second wire feeder 83 is included to align with second wire supply 40. The second wire feeder includes a drive roll 84 and support roll 86 and the system may include a second welding torch 88. In one embodiment, the second wire feeder 83 shares a common drive 46 (e.g., motor) with the first wire feeder 43. The control panel 18 may include a selector mechanism 33 enabling the user to select the desired wire feeder in order to advance wire from the appropriate wire supply. In this application, the user feeds the electrode wire 74, 76 to the respective wire feeders 43, 83 and then uses a selector mechanism 33 to select the desired wire supply. This enables the user to quickly alternate between the different wire supplies 36, 40 without having to swap wire supplies 36, 40 into one feeder 43. Similarly, the system may include a multi-wire feeder configured to receive wire from multiple sources. The multi-wire feeder may have independent drives or share a common drive. Furthermore, the system may include a positional adjuster coupled to the multi-wire feeder, or the multiple sources, or a combination thereof. The positional adjuster may facilitate the alignment of wire between the multi-wire feeder and the multiple sources.

Finally, in some embodiments, a multi-spool feeder and/or multiple wire supplies may be entirely or partially disposed within a suitcase, a backpack, a fanny pack or belt mounted luggage, a wrist mounted luggage, a shoulder mounted luggage, or a combination thereof. These luggage types may include a hard synthetic shell and may be made out of a plastic material, a durable fabric-like material, a metallic material, or a combination thereof. For example, the material may include polypropylene, polycarbonate, fiberglass, aluminum, synthetic material, etc. The luggage may also include a control panel for monitoring and adjusting the welding parameters.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a portable wire feeder, comprising:
a case configured to receive a first wire supply and a second wire supply; and
a wire feeder disposed in the case, wherein the wire feeder is configured to feed wire from the first wire supply and the second wire supply.

2. The system of claim 1, comprising a supply position adjuster configured to move the first wire supply, or the second wire supply, or both into alignment with the wire feeder.

3. The system of claim 2, wherein the supply position adjuster comprises a first supply adjuster configured to move the first wire supply and a second supply adjuster configured to move the second wire supply, wherein the first and second supply adjusters are configured to move independent from one another.

4. The system of claim 2, wherein the supply position adjuster comprises a common wire carriage configured to jointly move the first and second wire supplies.

5. The system of claim 1, wherein the first and second wire supplies are mounted in first and second fixed positions within the case, the wire feeder is mounted in a third fixed position within the case, and the fixed positions are configured to enable feeding of wire from either the first wire supply or the second wire supply into the wire feeder.

6. The system of claim 1, wherein the wire feeder comprises a feed position adjuster configured to move all or part of the wire feeder into alignment with the first wire supply and the second wire supply.

7. The system of claim 1, comprising a wire guide disposed between the wire feeder and the first and second wire supplies, wherein the wire guide is configured to align wire between the wire feeder and the first and second wire supplies.

8. The system of claim 1, comprising another wire feeder, wherein the other wire feeder is configured to align with the second wire supply and the wire feeder is configured to align with the first wire supply.

9. The system of claim 8, comprising a selector mechanism configured to select the wire feeder or the other wire feeder to advance wire from the first and second wire supplies.

10. The system of claim 8, wherein the wire feeder and the other wire feeder share a common drive.

11. The system of claim 1, wherein the case comprises a fixed handle, or a retractable handle, or a set of wheels, or a combination thereof.

12. The system of claim 1, comprising a moisture remover disposed in the case.

13. The system of claim 1, comprising a heater disposed in the case.

14. The system of claim 1, wherein the case comprises a plastic material, a durable fabric-like material, a metallic material, or a combination thereof.

15. A system, comprising:
a suitcase; and
a multi-wire feeder disposed in the suitcase, wherein the multi-wire feeder is configured to feed wire from multiple sources.

16. The system of claim 15, wherein the suitcase comprises a synthetic outer shell.

17. The system of claim 15, comprising a control panel coupled to the suitcase.

18. The system of claim 17, wherein the control panel comprises a welding control and a wire feed control.

19. The system of claim 15, wherein the multi-wire feeder comprises a plurality of wire feeders each configured to receive wire from at least one of the multiple sources.

20. The system of claim 19, wherein the wire feeders comprise a common drive.

21. The system of claim 15, comprising at least one positional adjuster coupled to the multi-wire feeder, or the multiple sources, or a combination thereof, wherein the positional adjuster is configured to align wire between the multi-wire feeder and the multiple sources.

22. The system of claim 15, comprising a moisture remover, or a heater, or a combination thereof disposed in the suitcase.

23. A system, comprising:
a luggage; and
a multi-spool feeder disposed within the luggage.

24. The system of claim 23, wherein the luggage comprises a hard synthetic shell.

25. The system of claim 23, comprising a control panel coupled to the luggage.
